(19) United States
(12) Patent Application Publication
(10) Pub. No.: US 2008/0252916 A1
(43) Pub. Date: Oct. 16, 2008

(54) INFORMATION REPRODUCTION METHOD AND DEVICE USING DOT PATTERN AND DOT PATTERN THEREOF

(75) Inventor: Gen-Dow Huang, Chung-Li City (TW)

Correspondence Address: APEX JURIS, PLLC, 12360 LAKE CITY WAY NORTHEAST, SUITE 410, SEATTLE, WA, 98125, US

(73) Assignees: Etoms Electronics Corp., Hsin-Chu (TW); Techsoft Technology Co., Ltd., Chung-Li City (TW)

(21) Appl. No.: 12/102,659

(22) Filed: Apr. 14, 2008

Related U.S. Application Data
(60) Provisional application No. 60/911,708, filed on Apr. 13, 2007.

(51) Int. Cl. G06F 15/00

(52) U.S. Cl. 358/1.9

(57) ABSTRACT

A reproduction information method and device using a dot pattern is provided. The dot pattern includes: the boundary dots, three direction dots and the code dots. The boundary dots are disposed regularly and continuously to define the blocks. Three direction dots are disposed on centers of three of the blocks to define a direction vector. Each of the code dots is disposed on one of the blocks without the direction dots. The code vectors are defined by the centers of the blocks to the code dots. The information is reproduced by the code vectors and the direction vector.

### CROSS-REFERENCES TO RELATED APPLICATIONS

This application is a non-provisional application of the U.S. provisional application Ser. No. 60/911,708 to Gen Dow Huang, entitled “Infornformation Reproduction Method And Device Using Dot Pattern And Dot Pattern Thereof” filed on Apr. 13, 2007.

### BACKGROUND OF THE INVENTION

1. Field of Invention

The invention relates to an information reproduction method and device, and more particularly, to an information reproduction method and device using a dot pattern.

2. Related Art

In the prior art, an information output method, which reads out a bar code printed on a printed material etc., and which has information such as a sound etc. outputted, has been proposed. For example, such a method that information which coincides with given key information has been stored in storage means in advance and information etc. is outputted by searching from the read key by use of a bar code reader has been proposed.

A dot pattern is generated in which minute dots were disposed by a predetermined rule, and a dot pattern which was printed on a printed material etc. is imported as image data by a camera, and digitized to have sound information outputted, has been proposed.

However, the above-described method which has a sound outputted by use of a conventional bar code has such a problem that a bar code printed on a printed material is unpleasant to the eye. Also, since a bar code is large and takes possession of a part of a page space, it has such a problem that, when a bar code is large as just described, it is impossible from the view point of a layout to assign a good many of bar codes in a way easy to understand with respect to each meaningful character and object which appear in partial text and sentence or in images of a photograph, a painting, a graphic.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### SUMMARY OF THE INVENTION

The present invention proposes a dot pattern that allows to reproduce information even if the dot pattern is visually negligible, and an information reproduction method and device using the dot pattern is proposed.

The present invention provides a dot pattern for reproducing information. The dot pattern includes: the boundary dots, at least three direction dots and the code dots. The boundary dots are disposed regularly and continuously to define the blocks. The direction dots are disposed on centers of at least three blocks to define a direction vector. Each of the code dots is disposed on one of the blocks without the direction dots. The code vectors are defined by the centers of the blocks to the code dots. The information is reproduced by the code vectors and the direction vector.

The present invention also provides an information reproduction method using an dot pattern. The method includes: scanning an image data including the dot pattern; detecting the boundary dots from the dot pattern; detecting at least three direction dots from the dot pattern; identifying a direction vector from the direction dots; detecting the code dots from the dot pattern; and decoding information.

The present invention also provides an information reproduction device using an dot pattern. The device includes: a scanner for scanning an image data including the dot pattern; a dot detector for detecting the boundary dots, at least three direction dots and the code dots from the dot pattern; a direction detector for identifying a direction vector from the direction dots; a code detector for identifying the code vectors from the code dots; and a decoder for decoding information by the code vectors and the direction vector.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 shows a 5*5 dot pattern according to the present invention.

FIG. 2 shows the relation between the direction dots and the direction vector according to the present invention.

FIG. 3 shows the relation between the code dots and the code vector according to the present invention.

FIG. 4 shows the information reproduction method using a dot pattern according to the present invention.

FIG. 5 shows the information reproduction device using a dot pattern according to the present invention.

FIG. 6 shows the block diagram of the scanner.

FIG. 7 shows one embodiment of the information reproduction device using a dot pattern.

### DETAILED DESCRIPTION OF INVENTION

A dot pattern for reproducing information is provided. The dot pattern is printed in a printed material. The user can reproduce information by using the dot pattern even if the dot pattern is extremely small and visually negligible.

The dot pattern includes boundary dots, direction dots and code dots. The boundary dots are disposed regularly and continuously to define the blocks B(i,j), i and j are integrals not less than 3. The direction dots are disposed on centers of the blocks B(1,1), B(3,1) and B(1,3). The direction dots define a direction vector 000-111. The code dots are disposed around centers of the blocks without the direction dots. The code vectors 000-111 are defined by the centers of the blocks to the code dots. The information is reproduced by the code vectors and the direction vector.

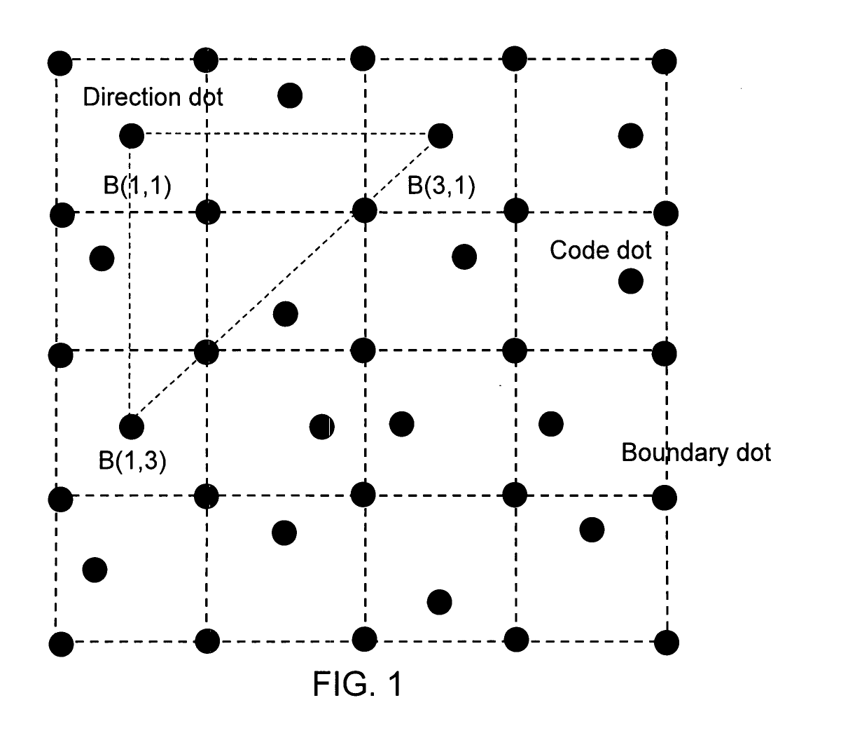

Please refer to FIG. 1. A 5*5 dot pattern is provided. The dot pattern includes 25 boundary dots for defining 16 blocks, 3 direction dots and 13 code dots. The boundary dots are disposed regularly and continuously to define the blocks B(1,1), . . . , B(4,4). The direction dots are disposed on centers of the blocks B(1,1), B(3,1) and B(1,3).

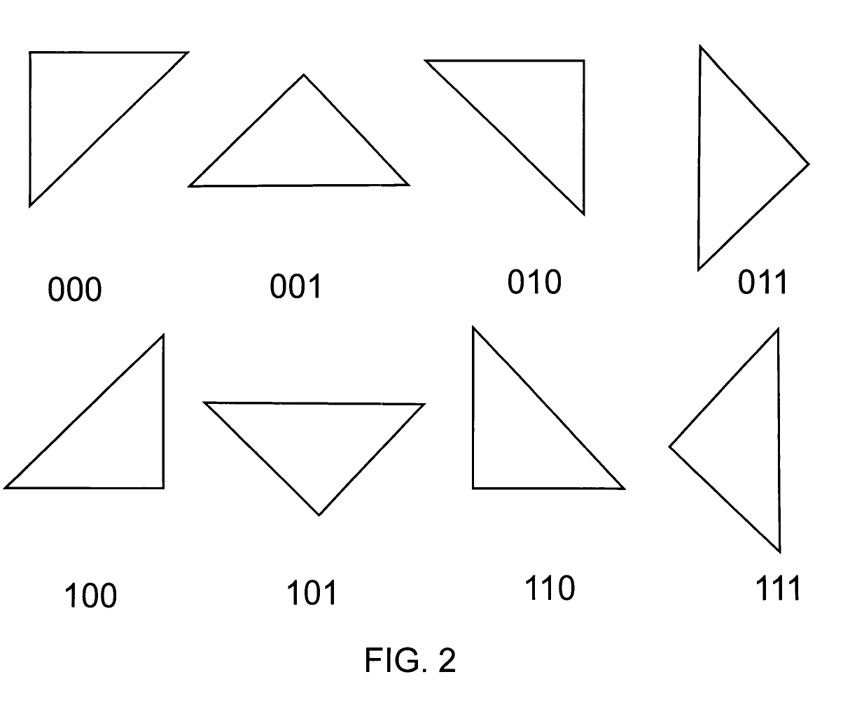

Please refer to FIG. 2. The relation between the direction dots and the direction vector is shown. The direction vector 000 to 111 is defined by different directions of a triangular formed by three direction dots. Although three direction dots are shown in FIG. 2, the direction vector can also be defined by more than three direction points.

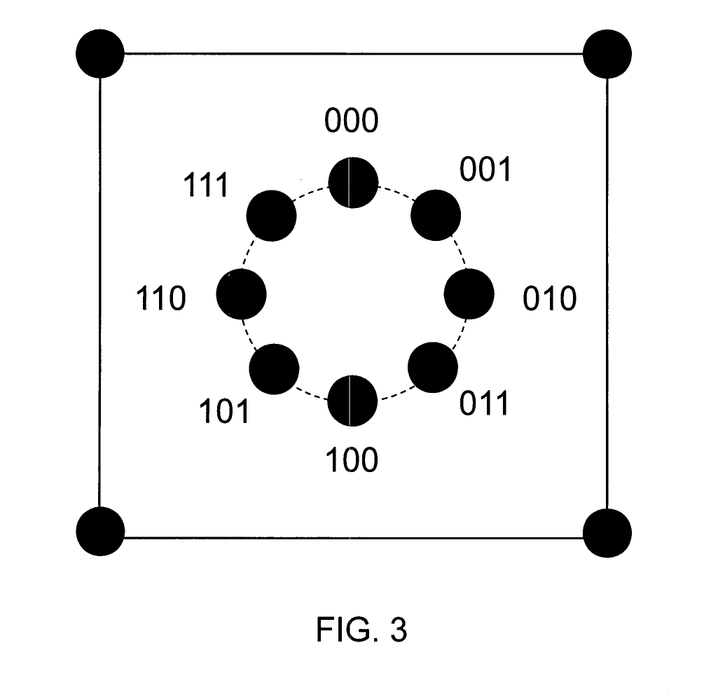

Please refer to FIG. 3. The relation between the code dots and the code vector is shown. Each of the blocks without the direction dot has one code dot. The code dot is disposed on one of eight points equally located on a circle around center of the block. The circle around center of the block has a fixed radius of ⅓ length from the center to the boundary dot of the block. The code vectors 000-111 are defined by the centers of the blocks to the code dots. The information is reproduced by the code vectors and the direction vector. For example, the information 101 is reproduced by the code vector 110 minus the direction vector 001 in binary operation.

The 5*5 dot pattern has 25 boundary dots defining 16 blocks, 3 direction dots and 13 code dots. Each code dot defines 8(2³) states 000-111, representing 3 bits of information. So the 5*5 dot pattern represents (2³)¹³=2³⁹ states, representing 39 bits of information.

The above operation can be applied to a 4*4, 5*5, 6*6 or higher level of dot pattern.

The 4*4 dot pattern has 16 boundary dots defining 9 blocks, 3 direction dots and 6 code dots. The 4*4 dot pattern represents 18 bits of information.

The 6*6 dot pattern has 36 boundary dots defining 25 blocks, 3 direction dots and 22 code dots. The 6*6 dot pattern represents 66 bits of information.

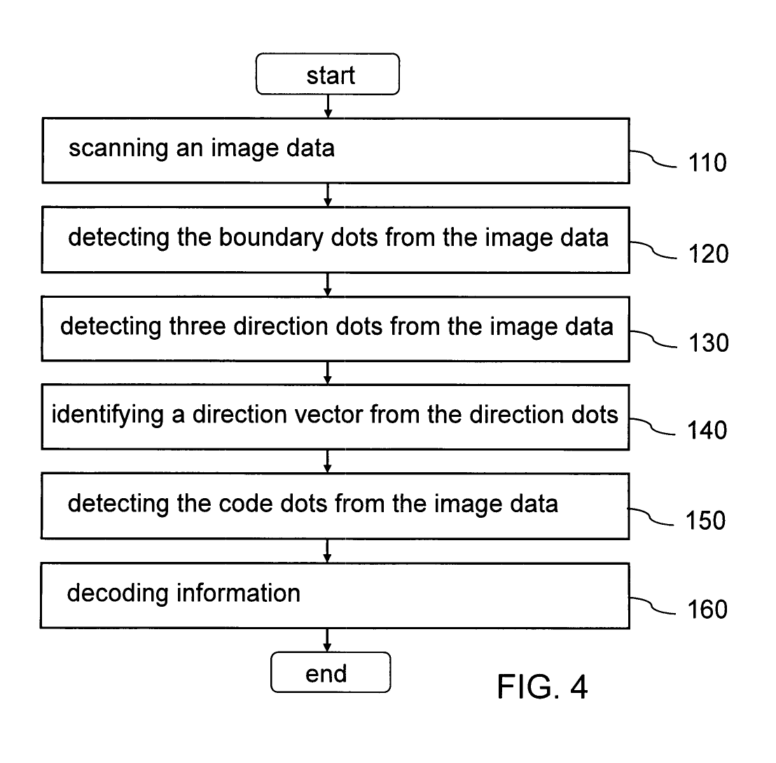

Please refer to FIG. 4. An information reproduction method using a dot pattern is provided.

The method includes:

Step 110: scanning an image data including a dot pattern;

Step 120: detecting the boundary dots from the image data, the boundary dots are disposed regularly and continuously to define the blocks;

Step 130: detecting three direction dots from the dot pattern of the image data, the direction dots are disposed on centers of three of the blocks B(1,1), B(3,1) and B(1,3);

Step 140: identifying a direction vector 000-111 from the direction dots;

Step 150: detecting the code dots from the dot pattern of the image data, each of the code dots is disposed around center of each of the blocks without the direction dots;

Step 160: decoding information from the code dots, the information is defined by a plurality of code vectors from centers of the blocks to the code dots and the direction vector.

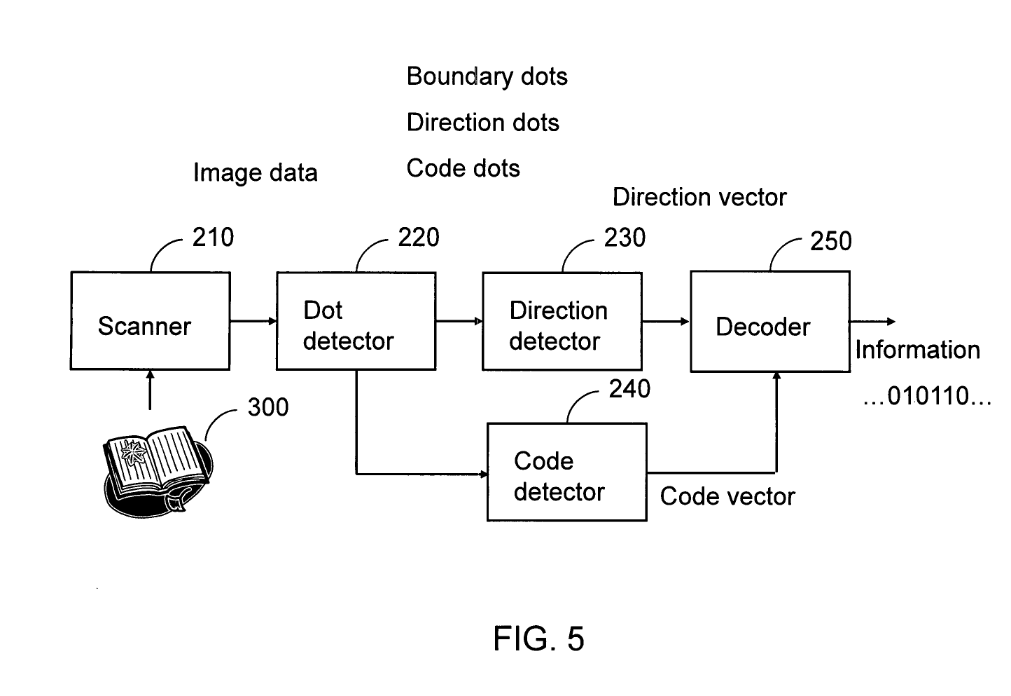

Please refer to FIG. 5. The information reproduction device using a dot pattern is provided.

The device includes: an image reader 210, a dot detector 220, a direction detector 230, a code detector 240 and a decoder 240.

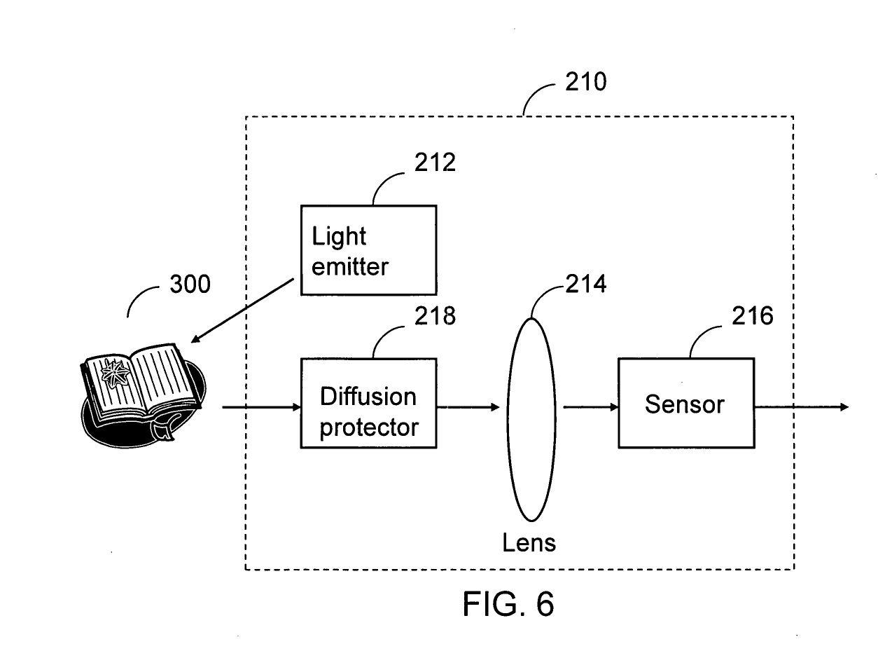

Please refer to FIG. 6. A block diagram of the scanner is provided.

The scanner 210 scans an image data including the dot pattern. The scanner 210 includes a light emitter 212, a lens 214 and a sensor 216. The light emitter 212 emits a light to an object 300 including the dot pattern. The lens 214 receives the light reflected from the object 300 including the dot pattern. The sensor 216 senses the image data from the light through the lens. The scanner 210 can also include a diffusion protector 218 between the object 300 and the lens 214, to prevent the reflected light from diffusion.

The dot detector 220 detects the boundary dots, the direction dots and the code dots from the dot pattern of the image data. The boundary dots disposed regularly and continuously to define the blocks. The direction dots are disposed on centers of at least three of the blocks; each of the code dots is disposed around center of each of the blocks without the direction dots.

The direction detector 230 identifies a direction vector from the direction dots.

The code detector 240 identifies code vectors 000-111 from the code dots. The code vectors are defined by centers of the blocks to the code dots.

The decoder 250 decodes information from the code vectors and the direction vector.

The dot decoder 220, the direction decoder 230, the code detector 240 and the decoder 250 can be implemented in a single chip.

The information decoded by the decoder 250 can be various kinds of multimedia information such as words, sound, speech, music, piture, image, video, and movie.

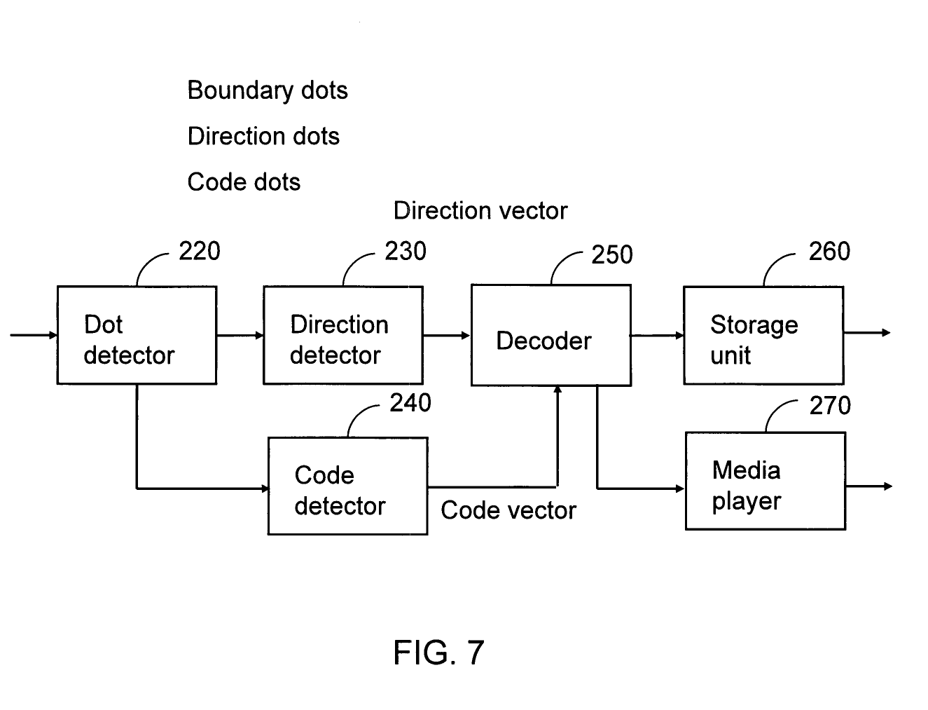

Please refer to FIG. 7. One embodiment of the information reproduction device using a dot pattern is provided.

A storage unit 260 can be included in the device, for storing the information decoded by the decoder 250. A media player 270 can also be included in the device, for playing the information decoded by the decoder 250.

The information reproduction method and device using a dot pattern according to the invention can be further utilized in against counterfeit, tour guide, audio picture frame, e-notebook, e-book, e-toy, e-learning, and supply chain management.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dot pattern for reproducing information, comprising:
a plurality of boundary dots, disposed regularly and continuously to define a plurality of blocks;
at least three direction dots, respectively disposed on one of centers of the blocks, the direction dots define a direction vector; and
a plurality of code dots, respectively disposed on one of the blocks without the direction dots, a plurality of code vectors are defined by centers of the blocks to the code dots;
wherein the information is reproduced by the code vectors and the direction vector.

2. The dot pattern of claim 1, wherein the direction dots are disposed on centers of the blocks in the first column with the first row, the third column with the first row and the first column with the third row.

3. The dot pattern of claim 1, wherein the information is reproduced by the code vectors minus the direction code.

4. The dot pattern of claim 1, wherein the code dots are disposed on one of eight points equally located on circles of a fixed radius around centers of the blocks.

5. The dot pattern of claim 4, wherein the fixed radius equals to ⅓ length from center to the boundary dot of the block.

6. The dot pattern of claim 1, wherein the 4*4 boundary dots defines 3*3 blocks.

7. The dot pattern of claim 1, wherein the 5*5 boundary dots defines 4*4 blocks.

8. The dot pattern of claim 1, wherein the 6*6 boundary dots defines 5*5 blocks.

9. The dot pattern of claim 1, wherein the 7*7 boundary dots defines 6*6 blocks.

10. An information reproduction method using a dot pattern, comprising the steps of:
scanning an image data including the dot pattern;
detecting a plurality of boundary dots from the dot pattern of the image data, the boundary dots are disposed regularly and continuously to define a plurality of blocks;
detecting at least three direction dots from the dot pattern of the image data, the direction dots are respectively disposed on centers of the blocks;
identifying a direction vector from the direction dots;
detecting a plurality of code dots from the dot pattern of the image data, each of the code dots is disposed around center of each of the blocks without the direction dots; and
decoding information, the information is defined by a plurality of code vectors from centers of the blocks to the code dots and the direction vector.

11. The method of claim 10, wherein the direction dots are disposed on centers of the blocks in the first column with the first row, the third column with the first row and the first column with the third row.

12. The method of claim 10, wherein the information is defined by the code vectors minus the direction code.

13. The method of claim 10, wherein the code dots are disposed on one of eight points equally located on circles of a fixed radius around centers of the blocks.

14. The method of claim 10, wherein the fixed radius equals to ⅓ distance from center to the boundary dot of the block.

15. An information reproduction device using a dot pattern, comprising:
a scanner, scanning an image data including the dot pattern;
a dot detector, detecting the dot pattern from the image data, the dot pattern including a plurality of boundary dots, at least three direction dots and a plurality of code dots, the boundary dots are disposed regularly and continuously to define a plurality of blocks, the direction dots are disposed on centers of the blocks, each of the code dots is disposed around center of each of the blocks without the direction dots;
a direction detector, identifying a direction vector from the direction dots;
a code detector, identifying a plurality of code vectors from the code dots; and
a decoder, decoding information from the code dots, the information is defined by a plurality of code vectors from centers of the blocks to the code dots and the direction vector.

16. The device of claim 15, wherein the direction dots are disposed on centers of the blocks of first column with first row, third column with first row and first column with third row.

17. The device of claim 15, wherein the decoder decodes the information by the code vectors minus the direction code.

18. The device of claim 15, wherein the code dots are disposed on one of eight points equally located on circles of a fixed radius around centers of the blocks.

19. The device of claim 15, wherein the fixed radius equals to ⅓ length from center to the boundary dot of the block.

20. The device of claim 15, further comprising: a storage unit for storing the information decoded by the decoder.

21. The device of claim 15, further comprising: a media player for playing the information decoded by the decoder.

22. The device of claim 15, wherein the scanner comprising:
a light emitter, emitting a light to an object including the dot pattern;
a lens, receiving the light reflected from the object including dot pattern; and
a sensor, sensing the image data from the light through the lens.
